(19) United States
(12) Patent Application Publication
(10) Pub. No.: US 2026/0341840 A1
(43) Pub. Date: Oct. 29, 2026

(54) COOLING LINE INTEGRATED BOX COVER FOR VEHICLE BATTERY PACK

(71) Applicant: LG Energy Solution, Ltd., Seoul (KR)

(72) Inventors: Jin Woo Park, Rochester, MI (US); Heekook Yang, Sterling Heights, MI (US); Juil Yum, Ann Arbor, MI (US)

(73) Assignee: LG Energy Solution, Ltd., Seoul (KR)

(21) Appl. No.: 19/374,089

(22) Filed: Oct. 30, 2025

Related U.S. Application Data
(60) Provisional application No. 63/794,879, filed on Apr. 25, 2025.

(51) Int. Cl. H01M 10/656; B60L 50/64; B60L 58/26; H01M 10/42; H01M 10/613; H01M 10/625; H01M 10/6554; H01M 50/204; H01M 50/249; H01M 50/271

(52) U.S. Cl. CPC H01M 10/656; B60L 50/64; B60L 58/26; H01M 10/425; H01M 10/613; H01M 10/625; H01M 10/6554; H01M 50/204; H01M 50/249; H01M 50/271; H01M 2010/4271; H01M 2220/20

(57) ABSTRACT

A battery pack assembly includes: a battery module system including one or more cooling plates and a coolant port connected to the one or more cooling plates; and a battery pack enclosure configured to enclose the battery module system, the battery pack enclosure including an opening to access the battery module system and a box cover for the opening, wherein the box cover includes a cooling assembly including: a cooling line connector to connect to the coolant port, and a quick connector connected to the cooling line connector and configured to connect to an external line.

### CROSS-REFERENCE TO RELATED APPLICATION(S)

This application claims the benefit of priority to U.S. Provisional Patent Application No. 63/794,879, filed Apr. 5, 2025, the entirety of which is incorporated by reference herein.

### TECHNICAL FIELD

Various embodiments of the present disclosure relate generally to leak management and, more particularly, to coolant connections for leak management for battery packs for electric vehicles.

### BACKGROUND

Batteries are increasingly being integrated into a wide range of mobile devices, including smartphones, laptops, electric vehicles (EVs), hybrid electric vehicles (HEVs), plug-in hybrid electric vehicles (PHEVs), and energy storage systems (ESS). Many batteries in locations deemed hazardous, such as inside of a vehicle, require additional safety precautions. One of these precautions is an enclosed (EE) box cover, which prevents the sparks from reaching or escaping the battery. The batteries may be included in a battery system with a battery enclosure. The battery enclosure may contain various components, such as battery cells, a battery cooling plate assembly, an EE box cover, one or more sensors, and a controller.

Batteries with EE box covers may include a cooling line that is mounted separately from the EE box cover. This requires extra space and structural elements, thus having a lower energy density, inefficient heat dissipation, and complex assembly.

The present disclosure is directed to overcoming one or more of these above-referenced challenges.

### SUMMARY OF THE DISCLOSURE

In some aspects, the techniques described herein relate to a battery pack assembly including: a battery module system including one or more cooling plates and a coolant port connected to the one or more cooling plates; and a battery pack enclosure configured to enclose the battery module system, the battery pack enclosure including an opening to access the battery module system and a box cover for the opening, wherein the box cover includes a cooling assembly including: a cooling line connector to connect to the coolant port, and a quick connector connected to the cooling line connector and configured to connect to an external line.

In some aspects, the techniques described herein relate to a battery pack assembly, wherein the battery pack assembly includes one or more cell stacks.

In some aspects, the techniques described herein relate to a battery pack assembly, wherein the cooling line connector includes an inlet port, an outlet port, and one or more cooling lines on the box cover.

In some aspects, the techniques described herein relate to a battery pack assembly, wherein the battery pack assembly includes a battery management system and a battery disconnect unit.

In some aspects, the techniques described herein relate to a battery pack assembly, wherein the battery pack enclosure is configured to direct all leaks from the cooling assembly to an external surface of the battery pack enclosure.

In some aspects, the techniques described herein relate to a battery pack assembly, wherein the box cover further includes one or more electrical components.

In some aspects, the techniques described herein relate to a battery pack assembly, wherein the coolant port includes cast aluminum.

In some aspects, the techniques described herein relate to a battery pack assembly, wherein the cooling line connector includes an injection-molded member.

In some aspects, the techniques described herein relate to a battery pack assembly, wherein the cooling line connector includes one or more quick connector joints, one or more O-ring seal joints, or one or more barbed tube joints.

In some aspects, the techniques described herein relate to a battery pack assembly, wherein the external line is a vehicle cooling line.

In some aspects, the techniques described herein relate to a battery pack assembly, wherein the external line is one or more of a coolant supply line or a coolant discharge line.

In some aspects, the techniques described herein relate to a battery pack assembly, wherein the cooling line connector includes a cooling line on an outside of the box cover.

In some aspects, the techniques described herein relate to a battery pack assembly, wherein a length of the battery pack enclosure is a sum of a length of the battery module system, a length of the coolant port, and an assembly tolerance.

In some aspects, the techniques described herein relate to a cooling assembly, the cooling assembly including: one or more cooling plates; a coolant port to connect to the one or more cooling plates; a cooling line connector to connect to the coolant port, wherein the cooling line connector is integrated in a cover of an enclosure; and a quick connector to connect to the cooling line connector, wherein the quick connector is configured to connect to an external line.

In some aspects, the techniques described herein relate to a cooling assembly, wherein the cooling line connector further includes: an inlet port, an outlet port, a first cooling line to connect to the inlet port, and a second cooling line to connect to the outlet port.

In some aspects, the techniques described herein relate to a cooling assembly, wherein the inlet port, the outlet port, the first cooling line, and the second cooling line are on the cover.

In some aspects, the techniques described herein relate to a cooling assembly, wherein the first cooling line and the second cooling line include one or more of metal or plastic.

In some aspects, the techniques described herein relate to a system including: a battery pack enclosure to enclose a battery system including one or more cooling plates, the battery pack enclosure including a box cover; and a cooling assembly integrated with the box cover of the battery pack enclosure and configured to connect to the one or more cooling plates.

In some aspects, the techniques described herein relate to a system, wherein the one or more cooling plates include a coolant port to connect to the cooling assembly.

In some aspects, the techniques described herein relate to a system, further including: a motor connected to the battery system, wherein the system is provided as a vehicle.

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary system infrastructure for a vehicle including a battery, according to one or more embodiments.

FIG. 2 depicts an exemplary system infrastructure for a battery with a controller, according to one or more embodiments.

FIG. 3. depicts a battery pack with a cooling line integrated EE box during assembly, according to one or more embodiments.

FIG. 4. depicts a battery pack with a cooling line integrated EE box after assembly, according to one or more embodiments.

FIG. 5. depicts an integrated cooling line in a battery pack enclosure, according to one or more embodiments.

FIG. 6. depicts a front view of an integrated cooling line in a battery pack box cover, according to one or more embodiments.

FIG. 7. depicts a rear view of an integrated cooling line in a battery pack box cover, according to one or more embodiments.

### DETAILED DESCRIPTION OF EMBODIMENTS

Both the foregoing general description and the following detailed description are exemplary and explanatory only and are not restrictive of the features, as claimed. As used herein, the terms “comprises,” “comprising,” “has,” “having,” “includes,” “including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. In this disclosure, unless stated otherwise, relative terms, such as, for example, “about,” “substantially,” and “approximately” are used to indicate a possible variation of ±10% in the stated value. In this disclosure, unless stated otherwise, any numeric value may include a possible variation of ±10% in the stated value.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section.

Various embodiments of the present disclosure relate generally to leak management and, more particularly, to coolant connections for leak management for battery packs for electric vehicles.

In some battery packs, external cooling systems provide better thermal propagation endurance than internal cooling systems but take up more space, reducing volumetric energy density. Some separate mounting spaces for the EE box cover and cooling system may require extra sealing to meet IP requirements, increasing design complexity. Some separate mounting spaces for the EE box cover and cooling system may also complicate manufacturing, adding more components and assembly steps. One or more embodiments may integrate the cooling line into the EE box cover, which may maintain thermal propagation safety while considering space usage. One or more embodiment may enhance energy density, simplify assembly, and/or improve overall thermal management.

One or more embodiments may preserve the thermal propagation endurance of external cooling systems while reducing the additional space required by systems without an integrated cooling line. One or more embodiments may reduce sealing points, simplify the design, and/or reduce potential failure risks internal to a battery pack. One or more embodiments may streamline manufacturing, cutting down on assembly complexity and component count. One or more embodiments may enhance thermal management, structural efficiency, and pack energy density without compromising safety.

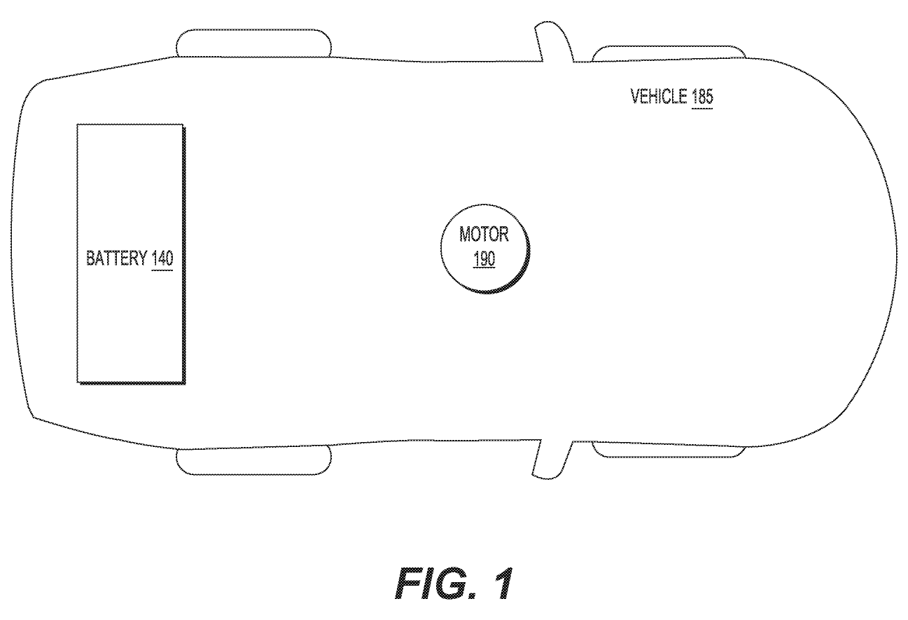

FIG. 1 depicts an exemplary system infrastructure for a vehicle including a battery, according to one or more embodiments. As shown in FIG. 1, vehicle 185 may include a motor 190, and a battery 140. Battery 140 may be a battery pack. Battery 140 may include one or more batteries. Battery 140 may include individual battery cells, and a controller configured to control either a charging of the battery 140 or a discharging of the battery 140. The battery 140 may provide electrical power to a motor 190. Vehicle 185 may include diesel powered vehicles, gasoline powered vehicles, hydrogen powered vehicles, electric powered vehicles, or hybrid vehicles.

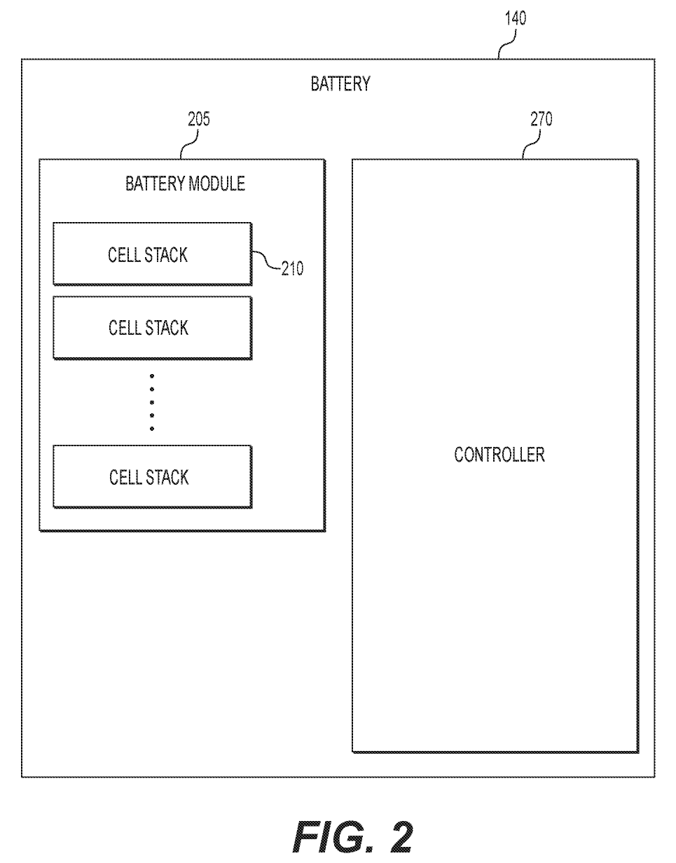

FIG. 2 depicts an exemplary system infrastructure for a battery with a controller, according to one or more embodiments. Battery 140 may include a battery module 205 and controller 270. Battery module 205 may include a plurality of cell stacks, for example cell stack 210.

Battery 140 may include a battery pack. Battery 140 may include an overcharge prevention apparatus. Overcharge prevention apparatus may include a voltage measuring unit, a current regulating unit, and a controller 270, and may further include one or more of a disconnecting unit, a current measuring unit, or a cooling unit. Additionally, when the overcharge prevention apparatus includes a disconnecting unit, a discharge inducing unit may be included.

The plurality of cell stacks, which may include cell stack 210, may be connected in series and installed on a high current path between two power terminals of battery 140. A voltage measuring unit may measure the voltage of each cell stack 210 and may generate a first monitoring signal indicating the measured voltage. The first monitoring signal generated by the voltage measuring unit may be transmitted to the controller. The current regulating unit may be configured to selectively provide each cell stack 210 with bypass paths connected in parallel. Current regulating units may provide bypass paths individually to the plurality of cell stacks.

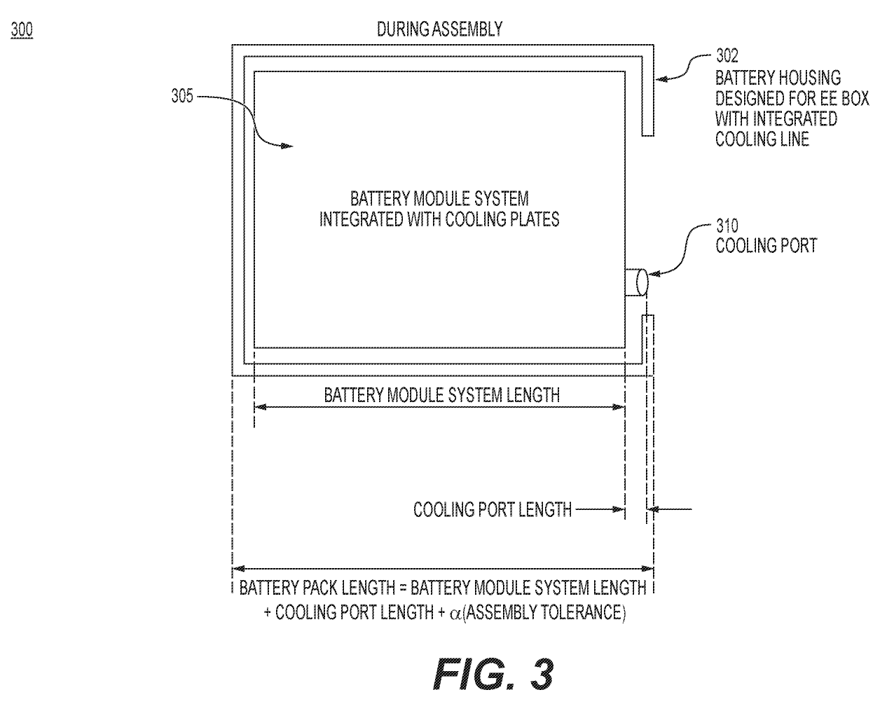

FIG. 3 depicts a battery pack with a cooling line integrated EE box during assembly, according to one or more embodiments. The battery assembly 300 may include battery module system 305 and battery pack enclosure 302. Battery pack enclosure 302 may enclose battery module system 305. Battery module system 305 may include cooling plates and coolant port 310. The length of the coolant port 310 may allow for shorter battery pack length and less unused space in the battery enclosure. The length of the battery pack enclosure 302 may be equivalent to the sum of the length of the battery module system 305 with the coolant port 310, and an assembly tolerance.

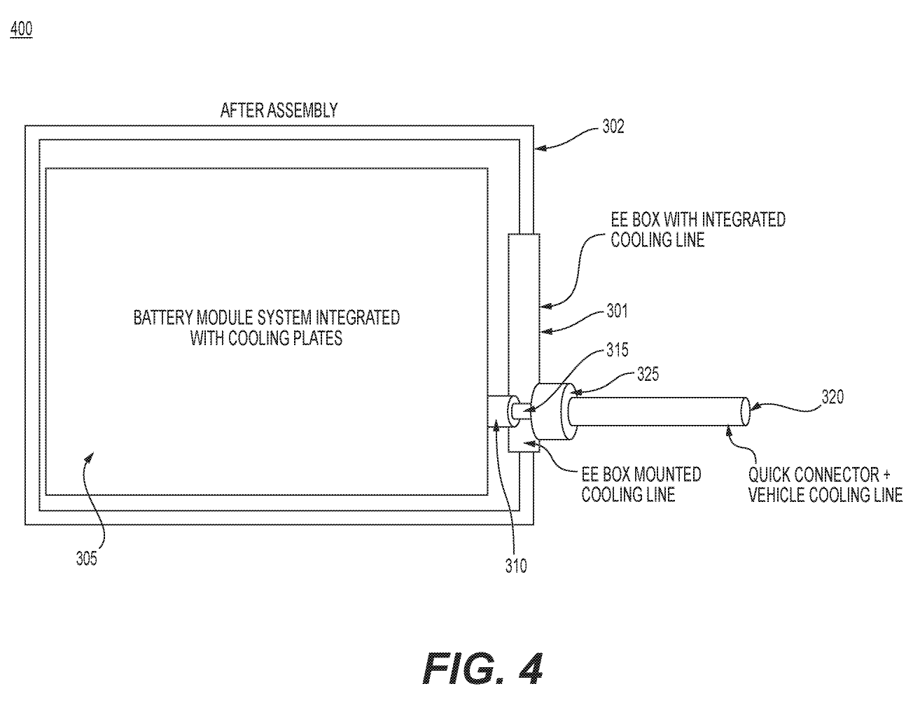

FIG. 4 depicts a battery pack with a cooling line integrated EE box after assembly, according to one or more embodiments. Battery assembly 400 may include battery module system 305, box cover 301, and battery pack enclosure 302. Battery pack enclosure 302 may enclose a battery module system 305. Battery module system 305 may include cooling plates and coolant port 310. The box cover 301 may include first connector 315. For example, first connector 315 may be disposed in box cover 301 while coolant port 310 is not disposed in box cover 301, and coolant port 310 may be connected to one or more cooling plates in battery module system 305. First connector 315 may be a cooling line connector. For example, first connector 315 may be fluidically connected to a quick connector 325 which may be fluidly connected to a supply or discharge line 320.

Coolant port 310 may connect from a cooling plate of battery module system 305 to outside of battery pack enclosure 302 through box cover 301. Coolant port 310 may be metal, such as cast aluminum, for example. Coolant port 310 may be welded to another component of battery assembly 400. For example, coolant port 310 may be welded to a cooling plate of battery module system 305. First connector 315 may be an injection-molded member extending from outside of the battery pack enclosure 302 to inside of the battery pack enclosure 302, the first connector 315 extending into an inside of the coolant port 310. First connector 315 may be plastic, such as PA66 plastic, for example. First connector 315 may include a quick connect fitting.

Coolant port 310 and first connector 315 may mate together to form a seal between the two components to allow a flow of fluid, such as coolant, through the two components. An opening of a connection between the coolant port 310 and first connector 315 may be located outside of battery assembly 400, box cover 301, or battery pack enclosure 302. The opening of the connection between the coolant port 310 and first connector 315 may be located such that any leakage of coolant from the connection is directed outside of the battery assembly 400. The opening of the connection between the coolant port 310 and first connector 315 may be disposed on an opening plate of the battery pack enclosure 302. For example, the opening of the connection between the coolant port 310 and first connector 315 may be disposed on or in box cover 301. The connection between the coolant port 310 and first connector 315 may include one or more quick connector joints, one or more O-ring seal joints, or one or more barbed tube joints.

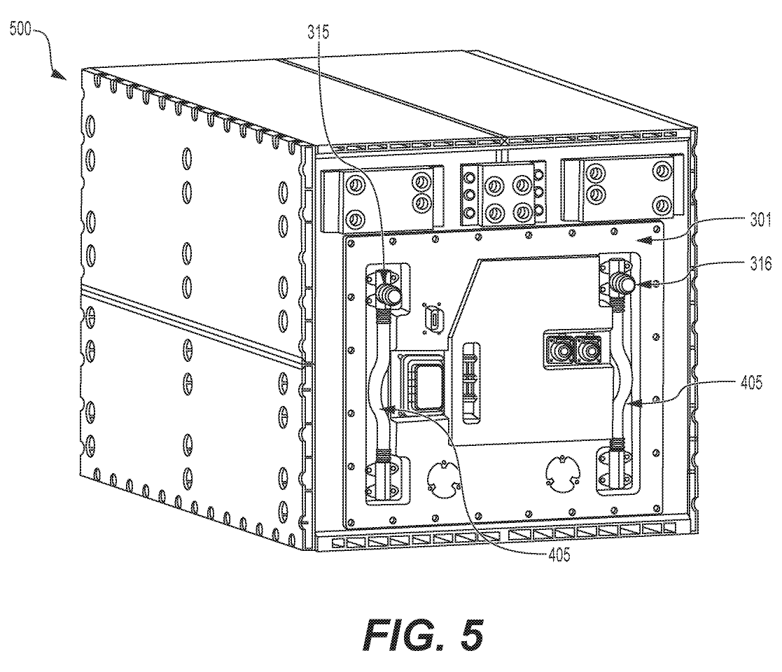

FIG. 5 depicts an integrated cooling line in a battery pack enclosure, according to one or more embodiments. Battery assembly 500 may include box cover 301 with an integrated cooling line. Box cover 301 may include first connector 315, second connector 316, and cooling line 405. Cooling line 405 may be connected to first connector 315. Cooling line 405 may be connected to second connector 316. First connector 315 may attach to quick connector 325 to connect with the supply or discharge line 320. Supply or discharge line 320 may be a vehicle cooling line. Battery assembly 500 may be installed in a vehicle 185, for example (e.g., battery 140). The opening of the connection between the coolant port 310 and first connector 315 may be located such that any coolant leak from the connection is directed to the external surface of the battery assembly 500. The opening of the connection between the coolant port 310 and first connector 315 may be disposed on an opening plate of the battery pack enclosure 302.

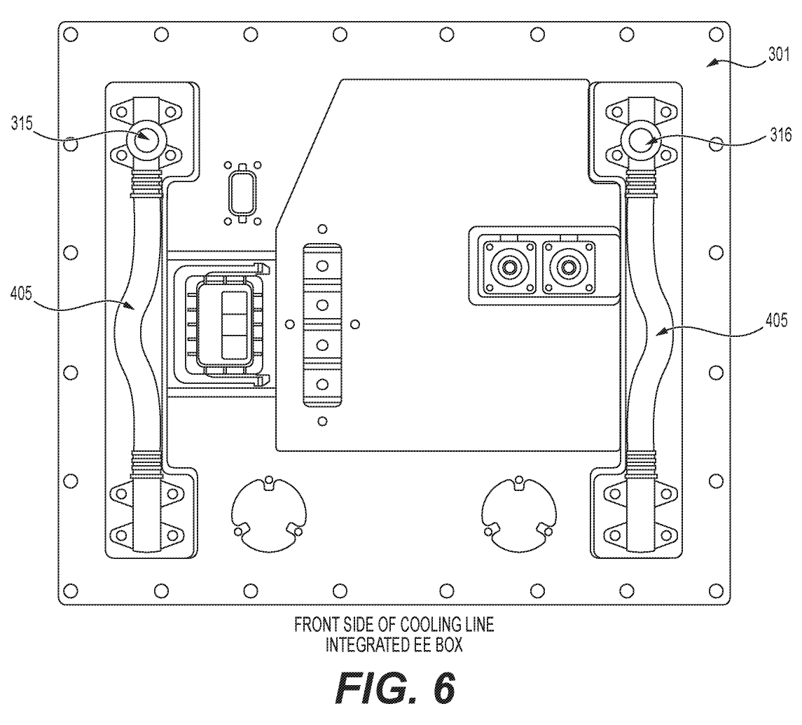

FIG. 6 depicts a front view of an integrated cooling line in a battery pack box cover, according to one or more embodiments. Box cover 301 may include first connector 315, second connector 316, and cooling line 405. The first connector 315 may act as the inlet port and the second connector 316 may act as an outlet port. For example, coolant port 310 may extend from inside of battery assembly 500 through box cover 301 to outside of battery assembly 500, where coolant port 310 may mate with one or more of first connector 315 or second connector 316. First connector 315 may connect to supply or discharge line 320. Second connector 316 may connect to supply or discharge line 320. Box cover 301 may be removed for access to the inside of battery assembly 500. Cooling line 405 may be metal or plastic.

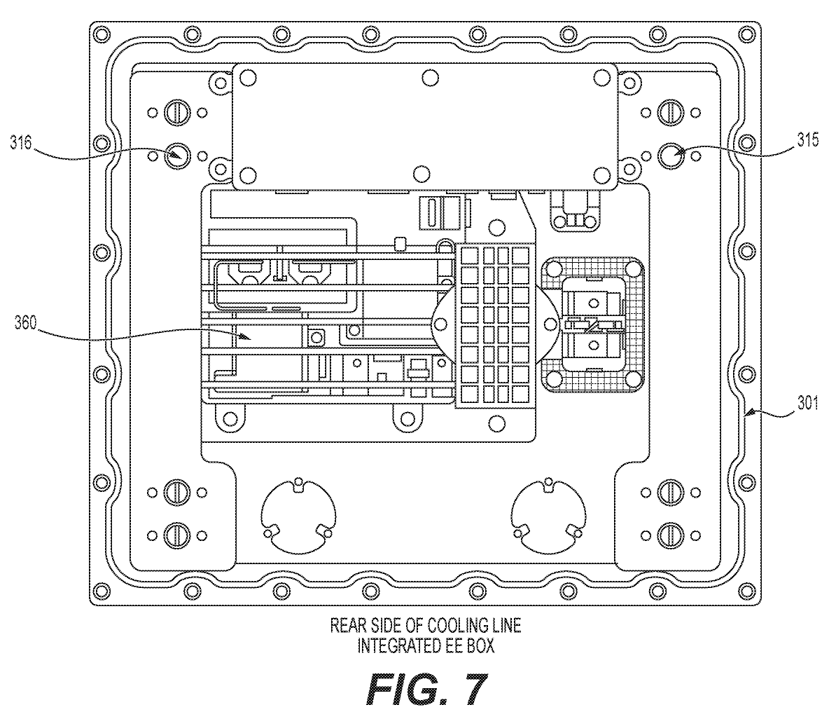

FIG. 7 depicts a rear view of an integrated cooling line in a battery pack box cover, according to one or more embodiments. Box cover 301 may include first connector 315 and second connector 316. Box cover 301 may include electrical components 360. Box cover 301 may be removed for access to the inside of battery assembly 500.

One or more embodiments may preserve the thermal propagation endurance of external cooling systems while reducing the additional space required by systems without an integrated cooling line. One or more embodiments may reduce sealing points, simplify the design, and/or reduce potential failure risks. One or more embodiments may streamline manufacturing, cutting down on assembly complexity and component count. One or more embodiments may enhance thermal management, structural efficiency, and pack energy density without compromising safety.

Other embodiments of the disclosure will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A battery pack assembly comprising:
a battery module system including one or more cooling plates and a coolant port connected to the one or more cooling plates; and
a battery pack enclosure configured to enclose the battery module system, the battery pack enclosure including an opening to access the battery module system and a box cover for the opening,
wherein the box cover includes a cooling assembly including:
a cooling line connector to connect to the coolant port, and
a quick connector connected to the cooling line connector and configured to connect to an external line.

2. The battery pack assembly of claim 1, wherein the battery pack assembly includes one or more cell stacks.

3. The battery pack assembly of claim 1, wherein the cooling line connector includes an inlet port, an outlet port, and one or more cooling lines on the box cover.

4. The battery pack assembly of claim 1, wherein the battery pack assembly includes a battery management system and a battery disconnect unit.

5. The battery pack assembly of claim 1, wherein the battery pack enclosure is configured to direct all leaks from the cooling assembly to an external surface of the battery pack enclosure.

6. The battery pack assembly of claim 1, wherein the box cover further includes one or more electrical components.

7. The battery pack assembly of claim 1, wherein the coolant port includes cast aluminum.

8. The battery pack assembly of claim 1, wherein the cooling line connector includes an injection-molded member.

9. The battery pack assembly of claim 1, wherein the cooling line connector includes one or more quick connector joints, one or more O-ring seal joints, or one or more barbed tube joints.

10. The battery pack assembly of claim 1, wherein the external line is a vehicle cooling line.

11. The battery pack assembly of claim 1, wherein the external line is one or more of a coolant supply line or a coolant discharge line.

12. The battery pack assembly of claim 1, wherein the cooling line connector includes a cooling line on an outside of the box cover.

13. The battery pack assembly of claim 1, wherein a length of the battery pack enclosure is a sum of a length of the battery module system, a length of the coolant port, and an assembly tolerance.

14. A cooling assembly, the cooling assembly comprising:
one or more cooling plates;
a coolant port to connect to the one or more cooling plates;
a cooling line connector to connect to the coolant port, wherein the cooling line connector is integrated in a cover of an enclosure; and
a quick connector to connect to the cooling line connector, wherein the quick connector is configured to connect to an external line.

15. The cooling assembly of claim 14, wherein the cooling line connector further includes:
an inlet port,
an outlet port,
a first cooling line to connect to the inlet port, and
a second cooling line to connect to the outlet port.

16. The cooling assembly of claim 15, wherein the inlet port, the outlet port, the first cooling line, and the second cooling line are on the cover.

17. The cooling assembly of claim 15, wherein the first cooling line and the second cooling line include one or more of metal or plastic.

18. A system comprising:
a battery pack enclosure to enclose a battery system including one or more cooling plates, the battery pack enclosure including a box cover; and
a cooling assembly integrated with the box cover of the battery pack enclosure and configured to connect to the one or more cooling plates.

19. The system of claim 18, wherein the one or more cooling plates include a coolant port to connect to the cooling assembly.

20. The system of claim 18, further comprising:
a motor connected to the battery system,
wherein the system is provided as a vehicle.
